(19) United States
(12) Patent Application Publication
(10) Pub. No.: US 2020/0193499 A1
(43) Pub. Date: Jun. 18, 2020

(54) SOCIAL NETWORK-BASED ASSET PROVISIONING SYSTEM

(71) Applicant: Albert Scarasso, Austin, TX (US)

(72) Inventor: Albert Scarasso, Austin, TX (US)

(21) Appl. No.: 16/798,015

(22) Filed: Feb. 21, 2020

Related U.S. Application Data
(63) Continuation-in-part of application No. 15/492,842, filed on Apr. 20, 2017.
(60) Provisional application No. 62/325,760, filed on Apr. 21, 2016.

(51) Int. Cl. G06Q 30/06; G06Q 20/02; G06Q 10/06; G06Q 50/00

(52) U.S. Cl. CPC G06Q 30/0613; G06Q 30/0641; G06Q 50/01; G06Q 20/02; G06Q 10/0635; G06Q 30/0623

(57) ABSTRACT

Embodiments are generally directed to providing a requestor with an asset that has been guaranteed by a guarantor, and to negotiating an asset guarantee with various guarantors. In one scenario, a computer system receives an asset request to guarantee a particular asset, accesses a database to retrieve attributes associated with the requestor and prepares a requestor cost function. The computer system then accesses attributes associated with third party participants and a third party cost function associated with the asset is prepared. Next, the requestor and third party cost functions are accessed to generate a new, optimized cost function with a guarantee from the third parties. A customized user interface is then generated that includes an interactive visual arrangement of items associated with the asset. Upon receiving a guarantee and a guarantee amount, the requestor is then provided with the asset according to the optimized asset guaranteeing terms.

### CROSS-REFERENCE TO RELATED APPLICATIONS

This application is a continuation-in-part of U.S. patent application Ser. No. 15/492,842 filed on Apr. 20, 2017, entitled “SOCIAL NETWORK-BASED ASSET PROVISIONING SYSTEM,” which claims priority to and the benefit of U.S. Provisional Patent Application Ser. No. 62/325,760, entitled “Lending Loan Optimization System,” filed on Apr. 21, 2016, all of which are incorporated herein by reference in their entirety.

### BACKGROUND

Social networks have become commonplace in today's world. Many people are members of various social networks, which attempt to connect those members to their friends, family members, work associates and acquaintances. These social networks allow members to interact with each other, post pictures, chat, read news, share media and perform other functions. In some cases, these social networks may be used for gathering individuals that are likeminded, or that have similar interests or hobbies.

Some users may wish to reach out to these likeminded individuals and request help obtaining an asset such as a product or service. These individuals may respond indicating an ability to help the individual obtain the asset they are seeking for. Often, however, these individuals lack the incentive to help the user obtain their asset, or lack information indicating why the user should receive help obtaining the asset.

### BRIEF SUMMARY

Embodiments described herein are generally directed to providing a requestor with an asset that has been guaranteed by a guarantor and to negotiating an asset guarantee with various guarantors. In one embodiment, a computer system performs a method including receiving data, from a requestor, including an asset request to guarantee a particular asset. The asset request includes identification information for the requestor. The method then includes accessing local or remote databases to retrieve information describing a set of attributes associated with the requestor. The set of attributes provides information for deriving a requestor cost function associated with the asset for the requestor. The cost function defines terms or conditions upon which the asset will be provisioned to the requestor.

The method next includes identifying, through a permission-based network connection within a social database, one or more third parties that are associated with the requestor, and accessing, within the social database, information relating to a set of attributes associated with the third party participants. The set of attributes provides information for deriving a third party cost function associated with the asset for the third party. Next, the method accesses the requestor cost function and the third party cost function to generate a new, optimized cost function for the asset for the requestor with a guarantee from the third parties, and generates a customized user interface that includes an interactive visual arrangement of items associated with the asset including the optimized cost function, a request for a guarantee associated with the asset, a risk level of the requestor, a guarantee amount, and a reward amount for providing the guarantee.

Still further, the method includes transmitting at least a portion of the customized user interface to the identified one or more third party participants and, upon receiving from at least one of the third party participants a guarantee and a guarantee amount, providing the requestor with the asset according to the optimized asset guaranteeing terms. Optionally, the method may include calculating a cost function for the asset representing a performance risk and filtering potential guarantors within the social database based on the calculated cost function for the asset.

In another embodiment, a computer system performs a method for negotiating an asset guarantee with various guarantors, which includes generating a user interface customized for a specific guarantor among different guarantors. The customized user interface presents to the guarantor attribute information associated with an individual. The method instantiates the generated user interface to present to the guarantor a guarantee request including a requested guarantee amount, a portion of the guarantee amount which is to be guaranteed by the guarantor, a total amount that is to be earned by the guarantor for guaranteeing the asset, and an indication of which other guarantors have agreed to guarantee the asset.

Next, the method includes receiving input from the guarantor accepting or denying the guarantee request. Upon receiving an indication that the guarantor denied the guarantee request, the method updates status information associated with the guarantor in an associated guarantor database. Furthermore, the method includes identifying guarantors as a replacement for the guarantor that denied the guarantee request, and recalculating one or more asset guarantor terms for the remaining guarantors including requestor cost function for the asset for the requestor, the guarantee amount for each guarantor and the reward for each guarantor.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a computer architecture in which embodiments described herein may operate including providing a requestor with an asset that has been guaranteed by a guarantor, and to negotiating an asset guarantee with various guarantors;

FIG. 2 illustrates a block diagram generally showing components and information inflow and outflow to a social network distribution optimization system;

FIG. 3 illustrates a block diagram including a user attributes table and a party condition matrix for an asset;

FIG. 4 illustrates a block diagram of a participant distribution optimizer;

FIG. 5A illustrates user interface embodiments for a financial industry use case;

FIG. 5B illustrates user interface embodiments for a service industry use case;

FIG. 6A illustrates an alternative user interface embodiment for a financial industry use case;

FIG. 6B illustrates an alternative user interface embodiment for a service industry use case;

FIG. 7 illustrates a block diagram of a participant distribution optimizer calculator;

FIGS. 8A & 8B illustrate block diagrams illustrating retrieval and filtering of social network connections;

FIG. 9 illustrates a block diagram in which a candidate scoring algorithm is implemented to score various participant candidates;

FIG. 10 illustrates a block diagram of an embodiment in which a candidates group optimization calculator is implemented to optimize participants;

FIG. 11 illustrates a block diagram of a computer system according to one embodiment;

FIG. 12 illustrates a block diagram of an implementation of a social network distribution optimization system in a financial environment;

FIG. 13 illustrates a block diagram of an implementation of a social network distribution optimization system in a service industry environment;

FIG. 14 illustrates an example party condition matrix for risk score and loan terms;

FIG. 15 illustrates an example party condition matrix for service job performance;

FIG. 16 illustrates an embodiment of a flowchart of a method for providing a requestor with an asset that has been guaranteed by a guarantor.

FIG. 17 illustrates an embodiment of a flowchart of a method for negotiating an asset guarantee with various guarantors.

### DETAILED DESCRIPTION

Embodiments described herein are generally directed to providing a requestor with an asset that has been guaranteed by a guarantor and to negotiating an asset guarantee with various guarantors. In one embodiment, a computer system performs a method including receiving data, from a requestor, including an asset request to guarantee a particular asset. The asset request includes identification information for the requestor. The method then includes accessing local or remote databases to retrieve information describing a set of attributes associated with the requestor. The set of attributes provides information for deriving a requestor cost function associated with the asset for the requestor. The cost function defines terms or conditions upon which the asset will be provisioned to the requestor.

The method next includes identifying, through a permission-based network connection within a social database, one or more third parties that are associated with the requestor, and accessing, within the social database, information relating to a set of attributes associated with the third party participants. The set of attributes provides information for deriving a third party cost function associated with the asset for the third party. Next, the method accesses the requestor cost function and the third party cost function to generate a new, optimized cost function for the asset for the requestor with a guarantee from the third parties, and generates a customized user interface that includes an interactive visual arrangement of items associated with the asset including the optimized cost function, a request for a guarantee associated with the asset, a risk level of the requestor, a guarantee amount, and a reward amount for providing the guarantee.

Still further, the method includes transmitting at least a portion of the customized user interface to the identified one or more third party participants and, upon receiving from at least one of the third party participants a guarantee and a guarantee amount, providing the requestor with the asset according to the optimized asset guaranteeing terms. Optionally, the method may include calculating a cost function for the asset representing a performance risk and filtering potential guarantors within the social database based on the calculated cost function for the asset.

In another embodiment, a computer system performs a method for negotiating an asset guarantee with various guarantors, which includes generating a user interface customized for a specific guarantor among different guarantors. The customized user interface presents to the guarantor attribute information associated with an individual. The method instantiates the generated user interface to present to the guarantor a guarantee request including a requested guarantee amount, a portion of the guarantee amount which is to be guaranteed by the guarantor, a total amount that is to be earned by the guarantor for guaranteeing the asset, and an indication of which other guarantors have agreed to guarantee the asset.

Next, the method includes receiving input from the guarantor accepting or denying the guarantee request. Upon receiving an indication that the guarantor denied the guarantee request, the method updates status information associated with the guarantor in an associated guarantor database. Furthermore, the method includes identifying guarantors as a replacement for the guarantor that denied the guarantee request, and recalculating one or more asset guarantor terms for the remaining guarantors including requestor cost function for the asset for the requestor, the guarantee amount for each guarantor and the reward for each guarantor.

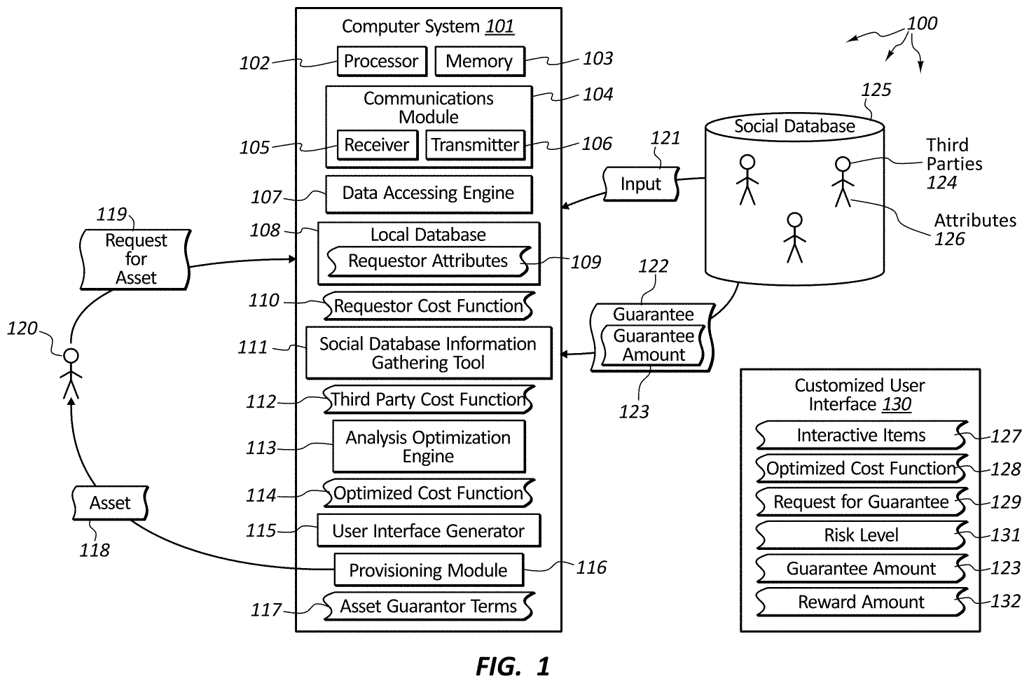

Turning now to the Figures, FIG. 1 describes a computing environment in which many different embodiments described herein can operate. The computer architecture 100 includes a computer system 101. The computer system 101 includes at least one processor 102 and at least some system memory 103. The computer system 101 may be any type of local or distributed computer system, including a cloud computer system. The computer system 101 includes modules for performing a variety of different functions. For instance, communications module 104 may be configured to communicate with other computer systems. The communications module 104 may include any wired or wireless communication means that can receive and/or transmit data to or from other computer systems (e.g. hardware receiver 105 or hardware transmitter 106). The communications module 104 may be configured to interact with databases, mobile computing devices (such as mobile phones or tablets), embedded or other types of computer systems.

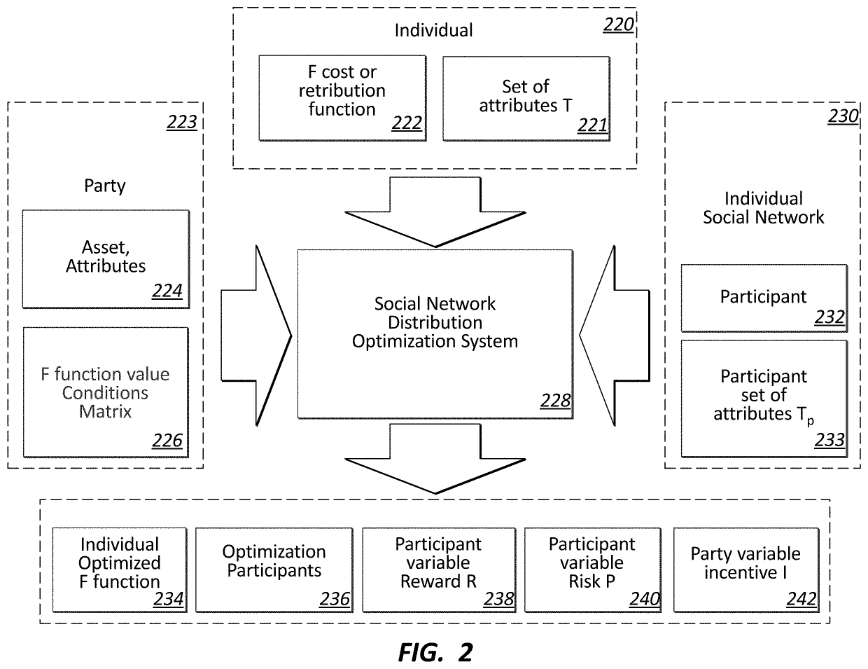

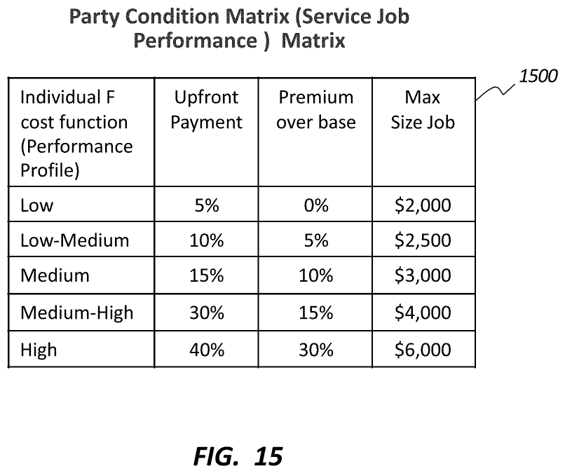

Each module in computer system 101 may include its own microprocessor, and may be located on a computer system other than computer system 101. The data accessing engine 107, for example, may be embodied on its own field programmable gate array (FPGA) or microprocessor. The data accessing engine is configured to interact with local databases (e.g. 108) or remote databases to access data including requestor attributes 109. A requestor 120 may provide a request for an asset 119 via an input method such as keyboard or touch. The request for an asset may be a request for a product, a service, a financial asset (e.g. a loan) or some other item. This product or service may be provided to the requestor 120 via an agreement. This agreement may be backed by a third party participant or guarantor. The guarantor makes decisions on which agreements to back based on the requestor attributes 109, among other information. Other modules and elements of FIG. 1 will be further described below with reference to FIGS. 2-17.

FIG. 2 illustrates a social network distribution optimization system (“SNDOS”) 228 that takes an individual's (individual 220) characteristics and attributes 221 and specifies them in terms of a function F (222). The function F represents a cost to the individual requestor to obtain an asset. The cost function 222 indicates, for example, that the individual 220 would need to fulfill or comply with the conditions 226 stipulated by another party 223. The party 223 may use the value of F (222) to generate a conditions matrix to set the terms associated with the asset based on attributes 224 of the asset.

The social network distribution optimization system 228 may be linked to various social networks 230 that each have people who are willing to be participants in a guarantee. Each participant 232 may have associated attributes 233 that help match the participant with a specific requestor or a specific asset, participants may be selected based on a variety of criteria including association with the requestor, association with the asset, familiarity or experience with being a guarantor, etc. The individual function F may be optimized from a party's perspective by the participation of such participants in the social network. Through a combined analysis of the individual and participants' sets of attributes, the SNDOS can implement an optimization process that calculates a participant's risk variable P (240) associated between the participant and the party. It can also calculate a participant's reward variable R (238) for taking such a risk, and an incentive variable I (242) that represents an incentive for the party to accept inclusion of the participants 232. SNDOS 228 may implement a real-time iterative opt-in process to enlist optimized participants 236 according to the optimization of the individual's function F (234).

The use of such social network distribution optimization system can be applied to different types of businesses including, but not limited to, businesses in the service industry and businesses in the financial industry. In the case of the financial industry, a borrower (individual 220) has a credit risk profile (function F) 222 and based on a set of attributes including, but not limited to, credit score, amount of loan paid off, number of late payments, loan payment amounts, duration of the loan (set of attributes T) 221 determine the terms and conditions including the amount, interest rate, and payment periods of a loan associated with a party 223 (i.e. the lending provider or lender).

In general, a person with no credit history or poor credit score can obtain a loan by having a guarantor that takes over the loan in the event of default. However, such guarantor participation only influences whether the loan is extended to the individual borrower. It doesn't lower the interest rate and associated loan payment for the individual borrower loan. The guarantor bears the overall risk of the default without any economic gain in the transaction from the lender, nor does borrower benefit in terms of better loan terms from the guarantor's participation.

By introducing the social network distribution optimization system 228 to a borrower (e.g. 220) in a lending system, the SNDOS can tap into the borrower's social network 230 to identify individuals that may wish to participate as guarantors. These individuals may be associated with the borrower, either directly or distantly. Each potential guarantor may have their own set of associated attributes Tₚ (233). SNDOS 228 uses the values of the set of attributes T to calculate a score to prioritize each individual. Then, through an iterative method of optimization for a given plurality of participants (i.e. a “guarantor circle”), the SNDOS calculates a new collective set of attributes T to improve the value of function F (the credit risk profile) for the borrower. The new set of attributes T is influenced by the participation of new guarantors which, from a lender standpoint, makes the loan more secure.

The SNDOS 228 calculates the risk variable P (the “guarantee amount”) (240) and the variable reward R (the financial gain in terms of cash or rewards) (238) for each guarantor in the circle, as well as an incentive variable I (242) for the party 223 to accept the participants 232 in the optimization of the borrower's function F. The SNDOS starts a negotiation opt-in process by contacting each selected individual to present the risk variable P (the guarantee amount) and the variable reward R (the financial gain in terms of cash or rewards), and inquire as to his or her willingness to participate. Depending on the opt-in participants, the SNDOS 228 continues to iterate through the selection, optimization, and opt-in process of the list of participants 232 until it reaches an acceptable optimized value of function F and variable reward R and uses the optimized F to determine the updated participant variable risk P.

In the service industry, a customer C (individual 220) may hire a service from a party (223) such as delivery of an item, painting a house, performing lawn care or providing some other service. The service is hired for a price and has an associated cost function F (risk performance) (222) which depends on pre-established attributes T (221) (e.g. the number of successful projects on budget, on time, quality of service, etc.). The individual 220 may have social connections (participants 232) in one or more different social networks 230. From the customer's point of view, the provider and all participants (i.e. guarantors) are associated with a customer's performance risk level (e.g., low, low-medium, medium, medium-high, high) indexed by the F cost function 222, which is linked to attributes T (221). The SNDOS 228 generates an amount of payment, insurance requirements, etc., as well as a probability value that the party or the participants at that level may not fulfill the cost function F for an individual service hire.

In such an ecosystem, a higher-performance-risk individual's value may decrease temporarily if lower-performance-risk social connections serve as advocates for the individual and/or serve as guarantors for a given service hire. Using SNDOS 228, the individual's terms of service can be improved for a service hire with the support of the individual's social connections, while at the same time offering incentives for lower-performance-risk agents to opt-in as participants and temporarily lowering the individual's performance risk of unfulfillment for a specific party.

Thus, embodiments described herein comprise systems, methods, and apparatuses configured to optimize through network connections the cost function F of an asset and the overall risk and reward that the network connections receive to participate in optimizing the asset. In particular, embodiments include systems that receives a cost function F 222 for an individual 220 for an asset given such individual set of attributes T 221, and processes the conditions based on the cost function F required by a party 223 (e.g. service provider) to provide the asset. The system (SNDOS 228) then gathers, from a database (e.g. 230), a listing of network connected associates of the individual, generates an optimized cost function F 234 based upon collective set of attributes T of the individual (221) and the attributes of the individual's network connections (233).

The SNDOS also generates variables risk P 240 and participant reward R 238 for each individual's network connection as an incentive to participate in the process. Still further, the SNDOS 228 generates a variable I (242) for the party 223 providing the asset to accept the inclusion of the individual's network connections. Additionally, implementations described herein include systems that negotiate in real-time, where each individual's network connection reviews the variables risk P (240) and reward R (238) and opts in to participate and an iterative process to handle individual's network connection opt-out.

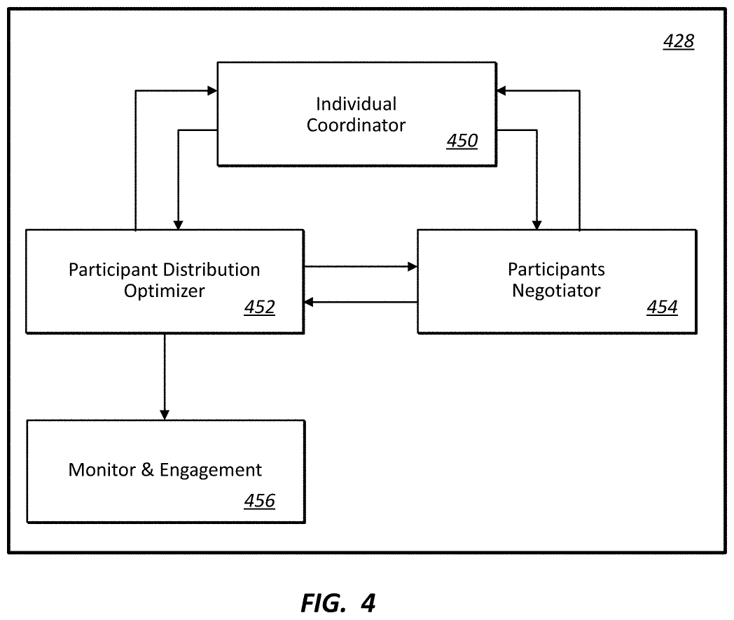

Embodiments disclosed herein may include a participant distribution optimizer (e.g. 452 of FIG. 4). Once an individual receives the terms for the asset from a party based on the individual cost function F, which is associated with the individual's set of attributes T, or is rejected by the party, the social network distribution optimization system evaluates different individuals that are part of the individual's social network and that have indicated their willingness to be participants in the optimization of individual cost function F. The SNDOS then uses the participants' set of attributes T to qualify the individual for the asset and/or optimize the cost function F of the individual's conditions associated with the asset.

The social network distribution optimization system uses multiple stages to qualify each individual's social network connection to be a participant in the optimization process: 1) An attribute selection process which selects the set of attributes Tₚ that will be used to evaluate an individual's fitness to become a participant (i.e. guarantor). The attributes Tₚ could be augmented from the individual set of attributes T with attributes that have additional predictability potential (e.g., an individual's cost-fulfillment record, behavioral indicators, life-style indicators, service data, financial data, etc.)

2) An initial filtering process selects the individual's network connections that, given their set of attributes Tₚ, have a F cost function for the asset that is better the individual's F cost function. These individual's network connections are now potential candidates for the optimization of the cost function F (222). An attribute matrix is created with one attribute vector per potential candidate. 3) An attribute vector optimization process implements a vector optimization algorithm to filter those candidates that show maximal values for the set of attributes Tₚ selected (“candidate vector”). 4) A scoring process where each candidate in the candidate vector is evaluated with a scoring algorithm and the candidate vector is sorted according to each candidate's score.

5) In an optimal terms calculation, a scoring algorithm assigns a numeric score to each participant record based on the participant's set of attributes Tₚ and then sorts the candidate vector by the participants candidate's score and, using a combinatorial and set of optimization algorithms, creates participants groups (combinations) each with an optimized individual F cost function, party incentive I, and for each participant variables Reward R and Risk P.

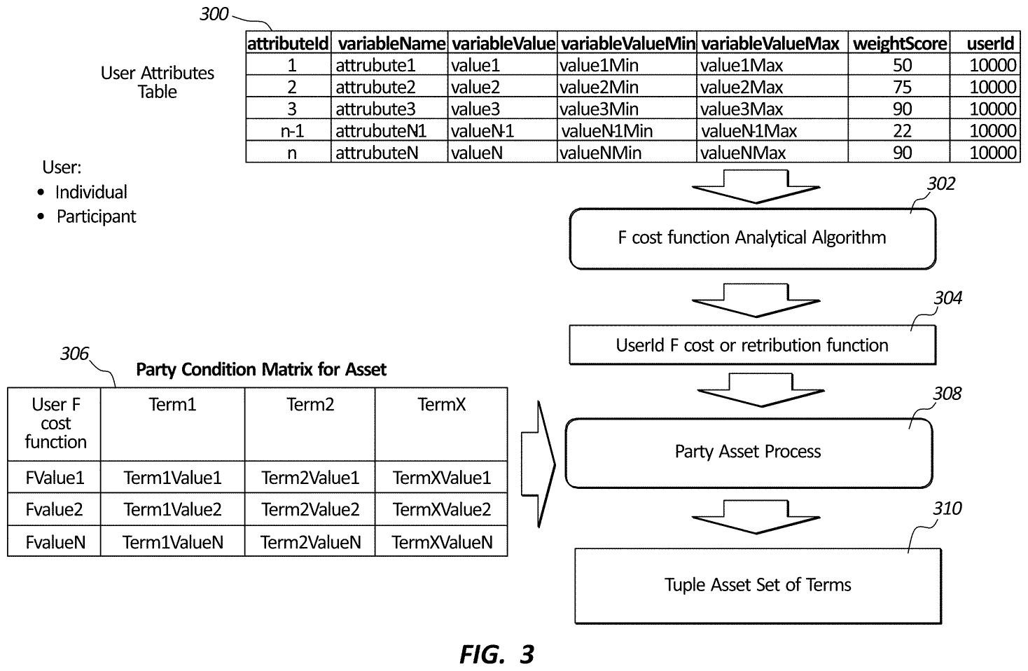

As shown in FIG. 3, the SNDOS can implement various entities, data flows and processes to determine the terms associated with a party asset for the party to provide the asset to the individual. The user attribute table 300 is a data structure that has a set of columns that include, but are not limited to, attribute identification, variable name, variable value, variable max value, variable min value and weight score. The weight score determines the relative importance of each attribute. A user may have a plurality of attribute records. Each attribute record has a specific meaning when it is associated with how a third party evaluates a user having such attributes. The set of attributes for a user is used collectively through an analytical algorithm 302 to determine a user F cost function 304 associated with the asset. The analytical algorithm can be a one or an ensemble of machine-learning algorithms that collectively can calculate, predict or derive a user F cost function. The user attribute table 300 represents the individual's set of attributes T (224) and the participant's set of attributes Tₚ (233).

The SNDOS 228 uses the F cost function analytical algorithm 302 to calculate, predict or derive the F cost function for both the individual and each participant associated with the individuals through a network connection. The Social Network Distribution Optimization System inputs the F cost function 304 and the party condition matrix for asset 306 into the party asset process 308 to identify conditions (or sets of terms) to be applied to a party asset based on F cost function value for the individual. The output of the party asset process 308 is a single tuple that has the tuple asset set of terms 310 for a user F cost function.

The party condition matrix for asset 306 is a table in a data store that has a plurality of columns (term₁, term₂, ermₙ₋₁, termₙ) and individual tuple instances for each value or level of F cost function. Such terms are then applied to a party asset to determine the cost, value, premiums, limitations, performance, milestones associated with the party assigning or transferring the party asset to the individual.

The social network distribution optimizer distributes the risk, either in the form of an amount, percentage of an asset, or negative points, to each potential individual's network connection, and sets a ranking number and the optimal risk percentage of guarantee or involvement for an asset (e.g. guarantee amount) for each individual individual's network connection with the goal of balancing improvement on the individual's F cost function while achieving a participant reward that justifies to take the risk on participating in guaranteeing the asset (e.g. performance or value). The social network distribution optimizer stores the optimized participants' selections and other potential participants in a storage device (“optimized participant selection”).

In at least one embodiment, a system includes a computing device display that presents to the individual associated with the acquisition of asset from a party, the approval or rejection of the asset and, if approved, the F cost function terms. If available, the computing device displays the list of potential participants that are part of the individual's social network, their participants' ranking, and risk portion for the associated asset by each participant in order to optimize F cost function terms.

The individual can submit a list of potential participants to the social network distribution optimizer. The social network distribution optimizer can then request participation from the identified participants. Additionally, the individual can modify the list of guarantors or increase/decrease the available guarantors and submit the selection to the social network distribution optimization system. When the selection is modified, the system sends the modified selection list to the SNDOS to re-calculate the individual's F cost function for the requested asset, as well as each participant's level of risk and reward. The new F cost function terms are then presented to the computing device display for evaluation by the individual. The social network distribution optimization system updates the new optimized guarantor selection in the storage device (“optimized participants selection”).

As shown in FIG. 4, the SNDOS 428 may include multiple components including a participants negotiator 454. When the individual selects to include multiple participants for an asset of a party (or an asset controlled by the party), the participants negotiator reads the optimized participants selection from the storage device and initiates a negotiation process with each participant. The process includes, but is not limited to, presenting to the participant information regarding the individual, the value of the asset (e.g. level of performance or amount), the percentage of risk associated with the asset and the reward associated with taking the risk. When the participant accepts the guarantee/involvement request, the participant negotiator updates the participant status in the storage device. When the participant rejects the guarantee/involvement request, the participant negotiator selects one or more participants as replacements, sending the new list to the social network distribution optimizer for recalculation of the individual F cost function, and risk and reward for the participant.

Embodiments disclosed herein also include a computing device display that presents to each participant the request for guarantee or involvement, along with associated data and controls to accept or reject the request. The computing device display also depicts a status bar that is controlled by the participant negotiator 454 and that shows the progress of the overall performance of the individual with regard to the compliance of terms and condition of the asset.

Additionally, embodiments disclosed herein also include a monitor and engagement process 456. When the individual misses a milestone related to the terms and conditions associate with the asset, the monitor and engagement process notifies the participants (guarantors) that are involved with the asset. The initial notification enables participants to communicate with the individual via a generated user interface. After the grace period for the missed milestone, the monitor and engagement process automatically transfers the agreed level of risk by participant from the individual, and the participant becomes responsible to the party that has the asset based on the participant F cost function. The participants will then need to start the performance agreed during the negotiations. Concurrently, the monitor and engagement process 456 establishes a new asset between the individual and the individual participant at the F cost function before the individual optimized F cost function. The party condition matrix 306 of FIG. 3 is indexed by the F cost function associated with the individual and participants. The F cost function could be associated to a several attributes for each F cost function value in the condition matrix.

In one embodiment, the social network distribution optimization system 228 includes multiple machine-learning algorithms that use the participant's set of attributes and other external data sources to quantify each participant F cost function associated with an asset from a party, while creating for each participant the optimal level of risk (amount or level of performance) in terms of guarantee of a percentage of the asset, level of reward to take in the risk, and the level of incentive for the party for allowing the participant participation. For example, two guarantors with the same F cost function may have different values for the same attribute in the set of attributes used to calculate the F cost function, but the specific attribute may result into a different ranking score in terms of priority selection based on the party associated with the asset.

As mentioned above, FIG. 2 outlines embodiments of data entities that can be used by the Social Network Distribution Optimization System 228 and the resulting output generated by the system. The individual 220's information includes all information related to the individual's set of attributes T 221 and the individual's original F cost or retribution function 222 generated by an asset evaluation process using the individual's set of attributes T 221.

The party 223 includes all information related to the party data attributes 224 such as preferences in individual's attributes 221, the party's asset characteristics, the number of individual social network participants, limits on the individual's F cost function, and a party F function value conditions matrix 226 that defines for the different individual's or participants' F cost function value the attributes associated with the asset. For the financial industry use case, the F cost function is the individual risk profile and the conditions matrix 226 sets the interest and the maximum amount for each risk profile. The individual social network 230 is a list of member individuals that have been linked to the individual through a request process of acceptance to be connected in a social network connection, hence the individual social network connections. The individuals in the network can be identified as individual's participants 232 having participant's set of attributes T 33 that include willingness to be a participant in optimizing the individual's F cost function, and attributes similar and potentially extended to determine the F cost function for an asset.

The Social Network Distribution Optimization System 228 analyzes individual the F cost function 221 linked to individual's set of attributes T 222, with the party data 223 and the availability of individual participants 232. The participants' set of attributes Tₚ 233 are also analyzed, through an optimization set of algorithms, to classify their participation in optimizing the individual's F cost function for the party's asset. Their overall contribution is used to create a collective, optimized F cost function 234 that when applied to the party's condition matrix 226 results in an improvement of the original individual's F cost function 222 and the associated terms and condition for individual to obtain the party's asset.

The SNDOS 228 calculates the collective F cost function by applying a set of heuristic algorithms that establishes the optimal percentage amount of participant variable risk for each individual participants 232. The Social Network Distribution Optimization System 228 also establishes the optimal individual's F cost function 234 between what the individual proposed optimized individual's F cost function would be and the underlined party's F cost function used for the participants 232 agreeing to be involved in guaranteeing party's asset, which is translated into calculated participant variable risk P 240. The individual participant's 232 participant variable reward R 238 is the economic reward or earn-out for the willingness to take the risk in the form of participant variable risk P 240, and be a guarantor for the party's asset 224.

The Social Network Distribution Optimization System 228 coordinates with the individual 220 the option of entering into a possible optimized individual's F cost function for the party's asset 24 based on a selected plurality of participants instead of the original individual's F cost function for the party's asset. The SNDOS 228 then negotiates with each individual participant 232 the participant's participation in an individual's F cost function. For example, the SNDOS presents liability in terms of the potential participant variable risk P 240 based on the percentage of the amount of guarantee of the party's asset (e.g. amount of money, time, reputation, etc.) and potential impact to the participant in a set of attributes Tₚ 233 (e.g. failed recommendations, reputation, creditworthiness). The participant variable reward R 238 is the economic reward (e.g. earn-out reward points and or earned-out amount) for guaranteeing party's asset loan. Each participant 232 can accept or reject the option to guarantee the asset 224.

The SNDOS 228 outputs the individual's optimized F cost function 234 for the party to use with the F function value conditions matrix 226, the plurality of optimization participants 236 that are guaranteeing the party asset, the participant variable reward R 238 associated with each the economic reward for guaranteeing the party's asset, the participant variable risk P 240 associated with the percentage of the amount, value, time or effort associated with each participant that the participant needs to provide if the individual fails to meet the terms and condition of the party, and party variable incentive I 242, which is a premium that is added to the party asset for the party to allow an optimized individual's optimized F cost function 34 with the participation of the optimization participants 236. Finally, the SNDOS 228 monitors the performance of the individual optimized F function 234 progress, engages the optimization participants to inform participants for lack of performance of individual 20, and potentially transfers the party asset liability to the individual.

The individual coordinator 450 of FIG. 4 manages data exchanges between the Social Network Distribution Optimization System 228 and the computing device of the individual. The individual coordinator 450 also coordinates the data flow with the participant distribution optimizer 452 and the participants negotiator 454 once a proposed individual optimized F cost function is accepted by the individual. The participant distribution optimizer 452 manages the process to find an optimized F cost function 234 for an individual once an original F cost function 222 is available, coordinates activities with the individual coordinator once a solution is found, and coordinates activities with participant distribution optimizer 452 to recalculate changes in the optimized F cost function based on changes by participant's inputs. The monitor and engagement module 456 monitors the performance of the optimized F cost function and applies necessary adjustment in the event of individual fails to meets its obligations with a party's term and conditions.

In at least one embodiment, the individual coordinator 450 receives from the participant distribution optimizer 452 the proposed optimized F cost function based on a selected plurality of participants, the names of the participants, and a list of additional alternate participants based in an optimal ranking (optimized F cost function 234). The individual coordinator 450 formats a display that includes the original F cost function and the optimized F cost function. The individual coordinator 450 then sends it to the individual's computing device.

The individual coordinator's interface enables the individual to change the participant distribution optimizer's 52 proposed optimal grouping of individual participants 236 by including alternate available participants. When the individual 220 makes changes to the optimized F cost function, the individual coordinator 450 sends the changes to the participant distribution optimizer 452 to recalculate the feasibility of the requested changes and recalculate the F cost function, participant variable reward R 238, the participant variable risk P for each participant as well as a new party variable incentive I for the new participant list. It then sends the resulting optimized F cost function to the individual's computing device.

The individual coordinator's interface enables the individual 220 to accept or reject the optimized F cost function. When the individual accepts the optimized F cost function, the individual coordinator 450 sends the optimized F cost function to the participants negotiator 454. The individual coordinator 450 also receives updates from the participants Negotiator 454 such as updates to the optimized F cost function with an updated participants selection list because of rejection of involvement by some participants, successful completion of involvement or guaranteed process for the optimized, F cost function and so on.

The participants negotiator 454 contacts each individual participant associated with the optimized F cost function (optimized participant group 236) and negotiates the individual participant participation. For each participant in the optimization participant group list, the participants negotiator 454 formats a display that includes the liability in terms of the participant variable risk P, in conjunction of a participant's F cost function that is associated with the participant set of attributes Tₚ 233. The display also includes the percentage or portion of the liability in terms of participant variable risk P as total liability allowed for the participant 232, and the participant variable reward R 238 in terms of the reward points and or earned-out amount for the involvement or guarantee of party's asset.

The participant negotiator 454's interface enables the individual participant to accept or reject being a participant. When the individual participants have responded to the requests, the participant negotiator 454 analyzes the response and updates the status of each one in an optimization participant group matrix. If a particular individual participant has rejected participating in the individual's F cost function involvement or guarantee associated to the party asset, the participant negotiator replaces the individual(s) participant with one or more alternate participant(s) with the highest optimization rank. It then sends the new optimization participant group list to the participant distribution optimizer 452 for reevaluation.

Once the participant distribution optimizer 452 returns the new optimized F cost function & terms and participant variables reward R and risk P and terms to the participant negotiator, the participant negotiator 454 proceeds to communicate it to the individual coordinator 450. When accepted by the individual 220, the participant negotiator proceeds to contact and negotiate with the replacement participants. The process is repeated until successful or all alternate participants are exhausted, and the participant negotiator notifies the individual coordinator 450 of the unavailability of participants and optimized F cost function.

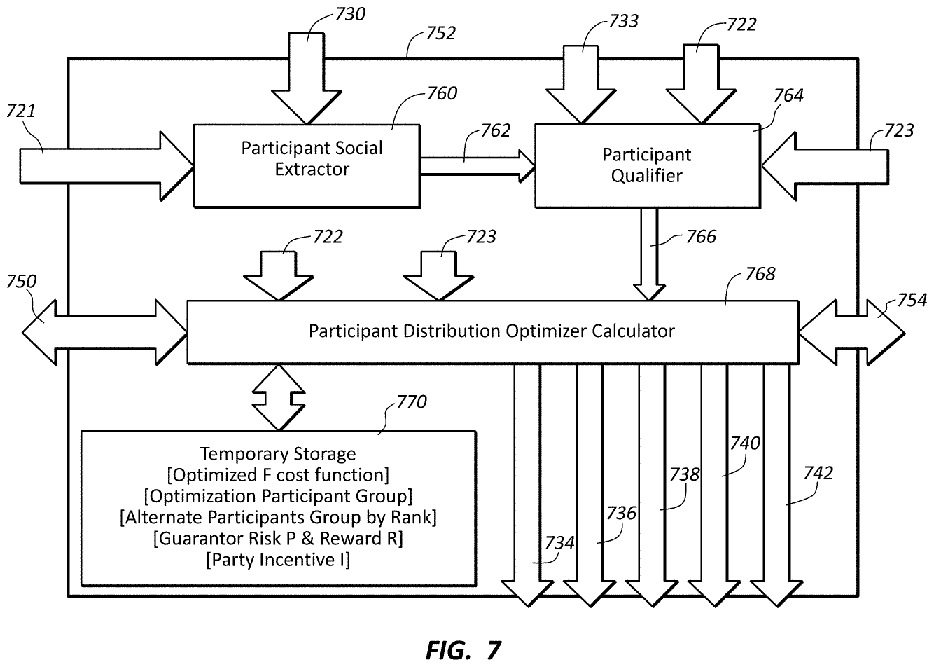

The participant distribution optimizer 452 manages the process and analysis of establishing the impact, or change on the F cost function 222 of individual participants as actors in the individual social network to optimize the terms of F cost function 22 for the individual for a specific party asset. In this context, optimizing includes making changes in the F cost function, such as lowering the cost for or increase the gains from the party's asset. The description of this component is discussed in more detail in the description of FIG. 7 below. The output of the participant distribution optimizer module 452 is the optimized F cost function 234, optimization participants 236, participant variable reward R 238, participant variable risk P 220, and party variable incentive I 242. The optimized F cost function 234 is sent to an asset evaluation system for completion of the transaction with the party, while elements 234, 236, 238, 240 and 242 are sent to the monitor and engagement module 456.

The monitor and engagement module 456 monitors the progress of the milestones associated with fulfillment (e.g. terms and conditions) of the party asset transaction that has a plurality of participants. For each individual milestone completion (e.g. payment made, job task completion), the monitor and engagement module 456 decreases each participant variable risk P 220 amount or value and increases each participant variable reward R 238 amount or value.

When the individual misses a milestone associated with fulfillment (e.g. terms and conditions) of the party asset transaction, the monitor and engagement module 456 notifies the participants of the missed milestone and the count down on the grace period for the individual 220 to address the missed milestone. When the individual is declared in default, the monitor and engagement module 456 transfers or instructs the party asset management system to have participants to take over the remaining asset portion as agreed based on each participant's variable risk P 220 amount or value.

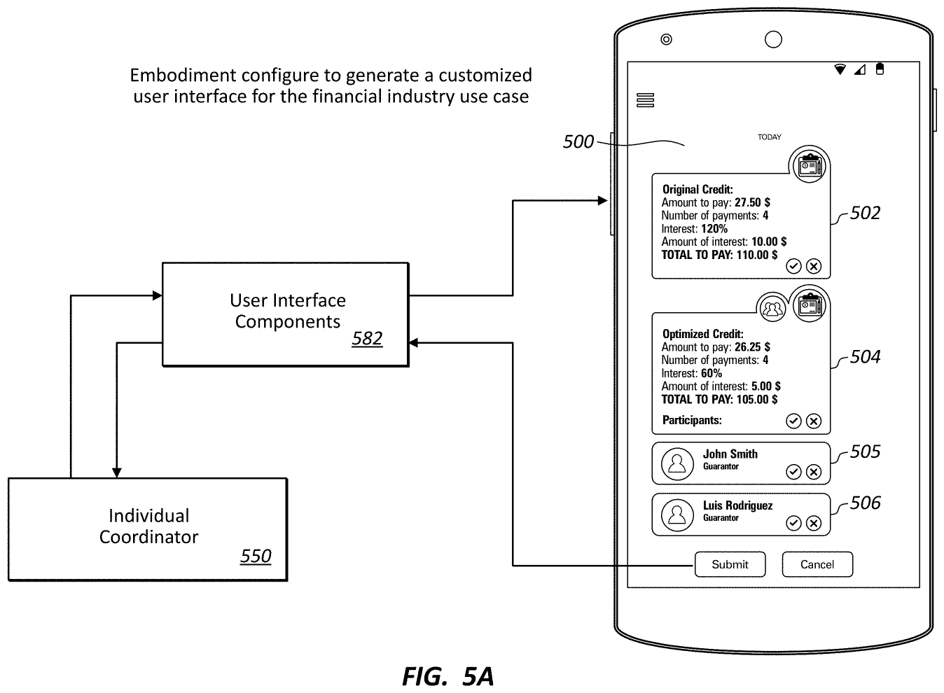

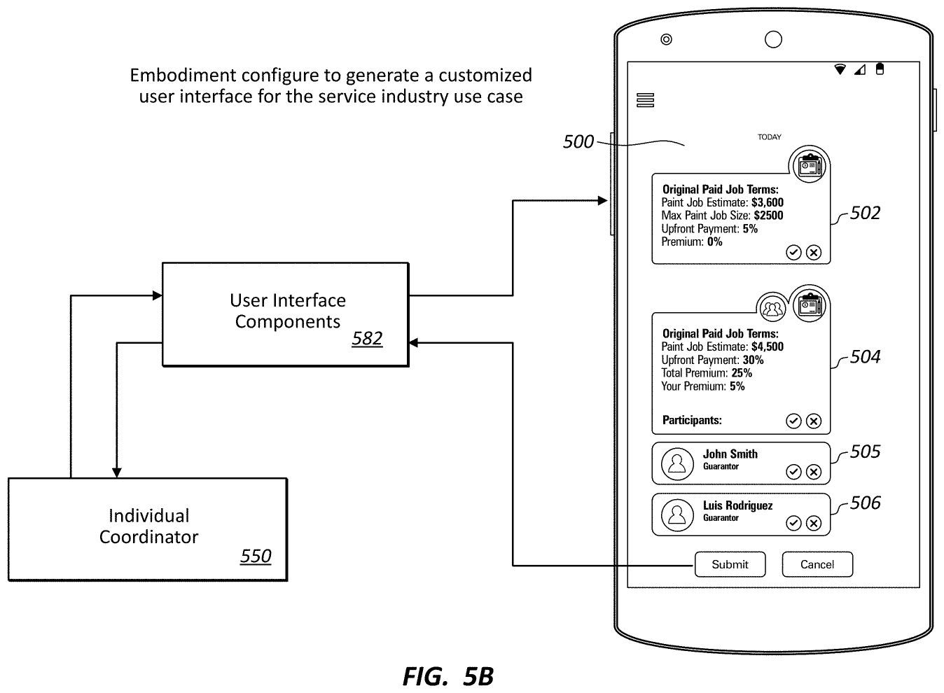

FIGS. 5A and 5B describe an embodiment in which a customized user interface 500 is generated. The individual coordinator 550 provides user interface components 582 which form the structure of the user interface. As shown in FIG. 5A, the user interface may be provided on a phone or other electronic device. The user interface (UI) 500 may include many different components including an indication of amount to pay, interest percentage, and amount to pay (502), along with an optimized version with a lower interest rate and a lower payment amount (504). The user interface 500 may also include representations of guarantors 505 and 506. Similar UI elements may be provided in a service industry use case, as shown in FIG. 5B. The UI 500 may show, for example, original service terms in 502, with optimized terms in 504, once guarantors 505 and 506 have agreed to participate. These figures will be described in greater detail below with regard to methods 1600 and 1700.

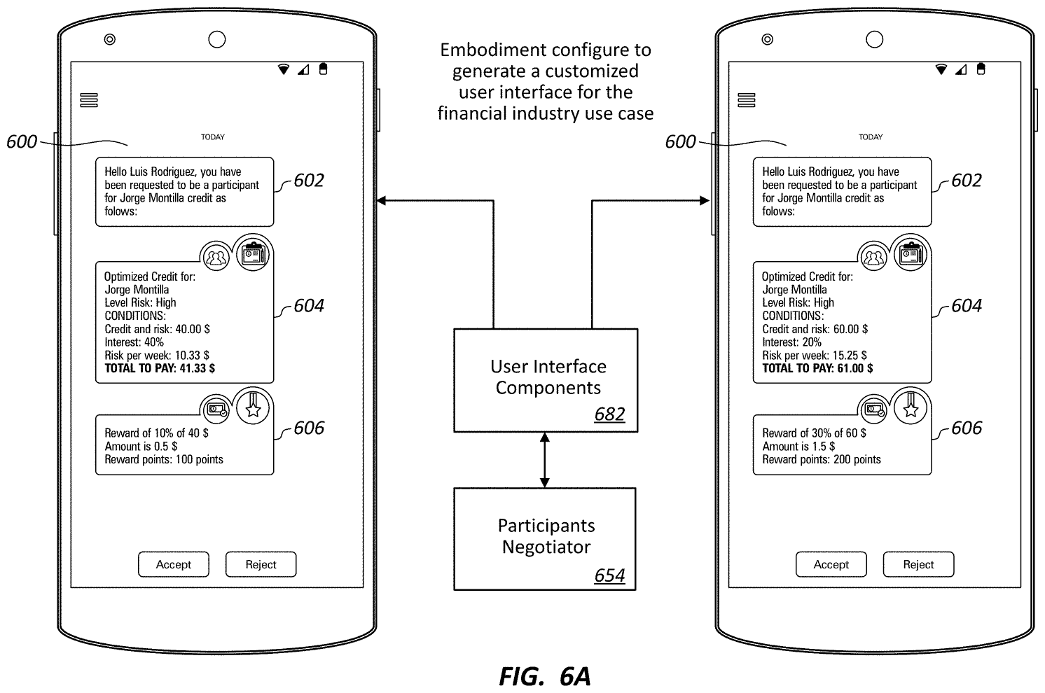

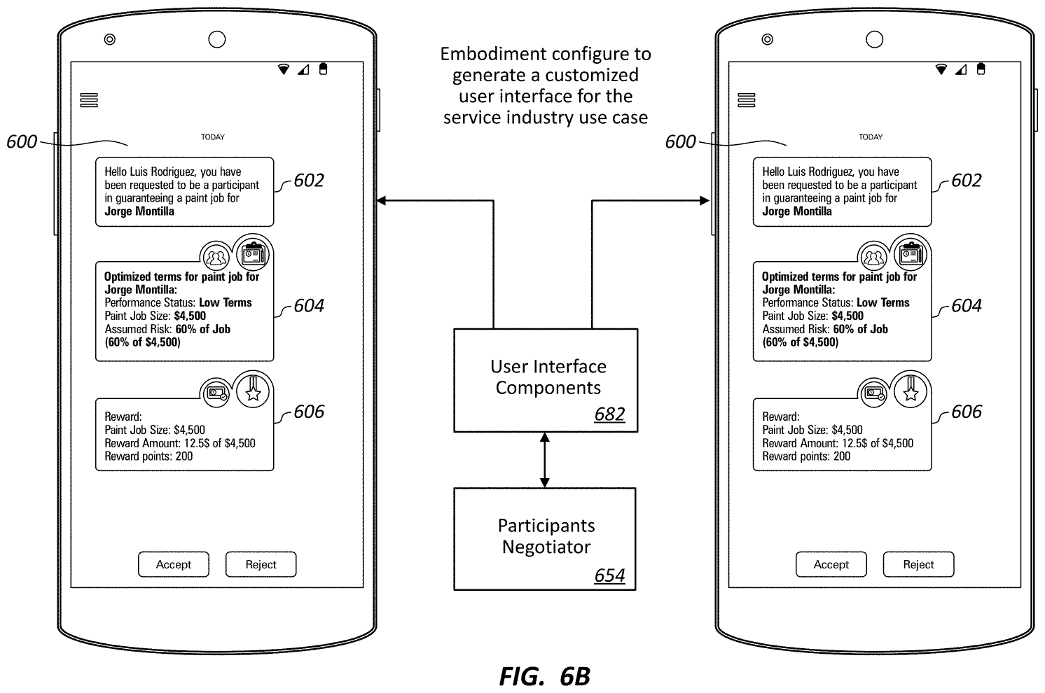

FIGS. 6A and 6B illustrate embodiments in which a customized user interface is generated for financial and service-based industries, respectively. In FIG. 6A, a user interface 600 is illustrated in which a social network associate is requested to be a guarantor (602). An optimized report for the requestor is shown in 604, and the associated reward is shown in 606. The participants negotiator 654 may provide these UI components 682 upon negotiating participants, as explained above. FIG. 6B shows similar UI elements used in a service industry use case, where a paint job is to be guaranteed. Guarantors are shown potential rewards (606), along with associated risks (604) and who is requesting the work (602). As with FIGS. 5A and 5B, FIGS. 6A and 6B will be described in greater detail below with regard to methods 1600 and 1700.

FIG. 7 provides an illustration of embodiments of components and flows between components of the participant distribution optimizer 452 of FIG. 4. The participant distribution optimizer 452 can include the following components: participant social extractor 760, participant qualifier 764, participant distribution optimizer calculator 768 and the temporary storage 770. The participant social extractor 760 accesses the social network storage and extracts all actors linked to the individual that has the participant status attribute active, and outputs 762 to the participant qualifier 764.

Participant qualifier 764 uses the list of qualified participants 762 and applies an attribute selection algorithm that, for each individual participant, selects the set of attributes Tₚ 733 that will be used to calculate a F cost function for the participant. Then the initial filtering process selects all participants that have a better F cost function (for the asset) than the individual's cost function F. Participant qualifier 764 applies party and asset rules that restrict conditions associated with the set of attributes Tₚ 733 for the participant. The participant qualifier 764 creates an attribute matrix with one attribute vector per potential candidate. It outputs the resulting participant list and participant attribute matrix 766, which includes the data in 733.

The participant distribution optimizer calculator 768 uses the list of qualified participants and corresponding attribute matrix 766, and applies a sequence of algorithms: a) an attribute vector optimization algorithm (e.g. Pareto but not limited thereto) filters those candidates that show maximal values for the set of attributes Tₚ 733 selected (i.e. the “candidate vector”), b) a scoring algorithm assigns a numeric score to each participant record based on the set of attributes Tₚ 733 and then sorts the candidate vector according to each candidate's score, c) using a combinatorial and set of optimization algorithms, calculator 768 creates participants groups of records, where each group is associated with an optimized individual F cost function, party incentive I, and for each group individual participant's variables reward R and risk R. The participant distribution optimizer calculator 768 selects the group record of participants with the best combination of optimal values and creates an alternate participants group by rank.

The participant distribution optimizer calculator 768 stores in temporary storage 770 the: optimized F cost function 734, optimization participant group 736, alternate participants group by rank, participant reward 738 and risk variables 740, and party incentive I 742. The participant distribution optimizer calculator 768 then forwards that information to the individual coordinator 450 and the participant negotiator 454. When either the individual coordinator 450 or the participant negotiator 454 modifies the optimization participant group, the participant distribution optimizer calculator 768 re-executes the advanced analytical optimization algorithm to derive a new set of data 770. When the participant negotiator 454 confirms the final version, the calculator 768 outputs optimized F cost function 734, the optimized group of participants 736, participant variables reward R 738 and risk P 740, and party incentive I 742.

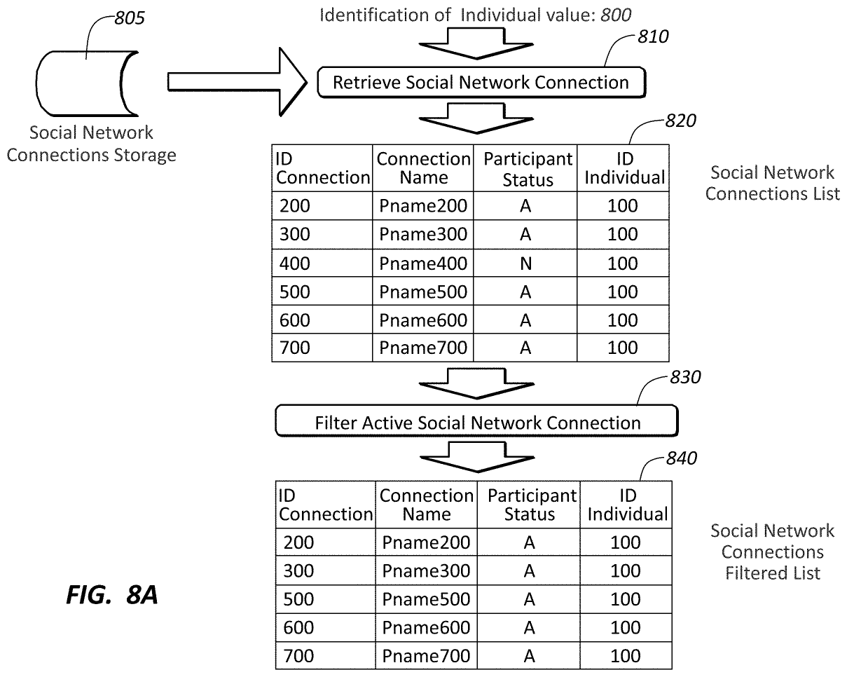

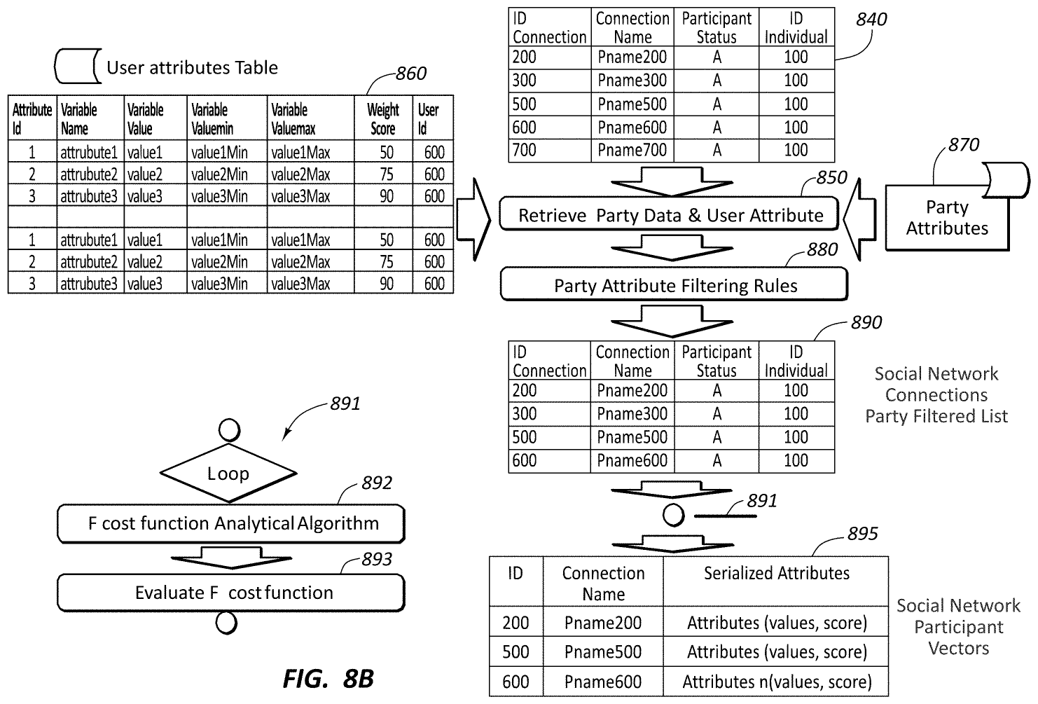

FIG. 8A provides an illustration of embodiments of data entities, data flow and processes that can be used by the participant social extractor 760 in FIG. 7 to retrieve the individual's social connection network and filter the list for the connection individuals that want to participate to optimize the F cost function of an individual. The individual has an identification of value 800 and an individual's F cost function of value has social network connection storage 800. In this embodiment, the example for the F cost function is a performance risk. Therefore, individuals in the social network connection are to have an F cost function less than the individual's F cost function.

The retrieve social network connection method step 810 retrieves the social network connection storage 800, resulting in the creation of a social network connection list 820. The list 820 contains an attribute participant status that individuals in the social network have set indicating their interest to be participant in the optimization of other social network individuals in his/her network. The expectation by setting the participant status to active is that the participant will receive an assessment of the risk to involvement or guaranteeing of the asset of a second party for the individual, as well as an indication of the reward that will receive in compensation for the risk taken and the ability to opt-in or reject in his/her participation. The filter active social network connection step 830 is then performed, which removes all social network connection individuals that don't have a participant status equal to active (‘A’) resulting in the social network connections filtered list 840.

FIG. 8B is an illustration of embodiments of data entities, data flow and processes that can be used by participant qualifier 764 in FIG. 7 that further reduces the list of social network connection individuals to a set of participants qualified to improve an individual's F cost function. The retrieve party data and user attribute step 850 retrieves the second party (holds the asset) attributes 870 restrictions related to an individual (user) attributes and, for each social network connection individual list 840, retrieves the individual (user) attributes record from the users attributes table 860. The party attribute filtering rules, business rules, or other rules based operations or algorithms, in combination with party attributes 870 remove social network connections 840 records resulting into a social network connections party filtered list 890.

The system then loops 891 through each entry in the social network connections party filtered list 890, and each the individual connection's attributes record from users attributes table 860. The F cost function analytical algorithm 892 in the loop 891 uses the connection's attributes record to calculate the individual connection's F cost function. The evaluate F cost function 820 compares the individual connection's F cost function with the individual's F cost function, which depending on the type of optimization criteria could be either be greater or less than the cost function. Individual connection records than don't meet the criteria are removed from the list 890, resulting into social network participant vectors 895 that also include a serialized vector of the attributes for each individual. In this embodiment, the example for the F cost function is a performance risk; therefore, all individual connection with F cost function greater than 90 (stated Individual's F cost function) are removed. The social network participant vectors 400 are the input into a set of optimization and heuristic algorithms as part of the participant distribution optimizer calculator 768 in FIG. 7.

The participant distribution optimizer calculator 768 applies a multi-objective optimization algorithm to provide the best candidates within the social network participant vectors 895. Multiple different algorithms may be used for multi-objective optimization including, but not limited to Pareto (e.g. 970), Genetic, Kung and other like algorithms.

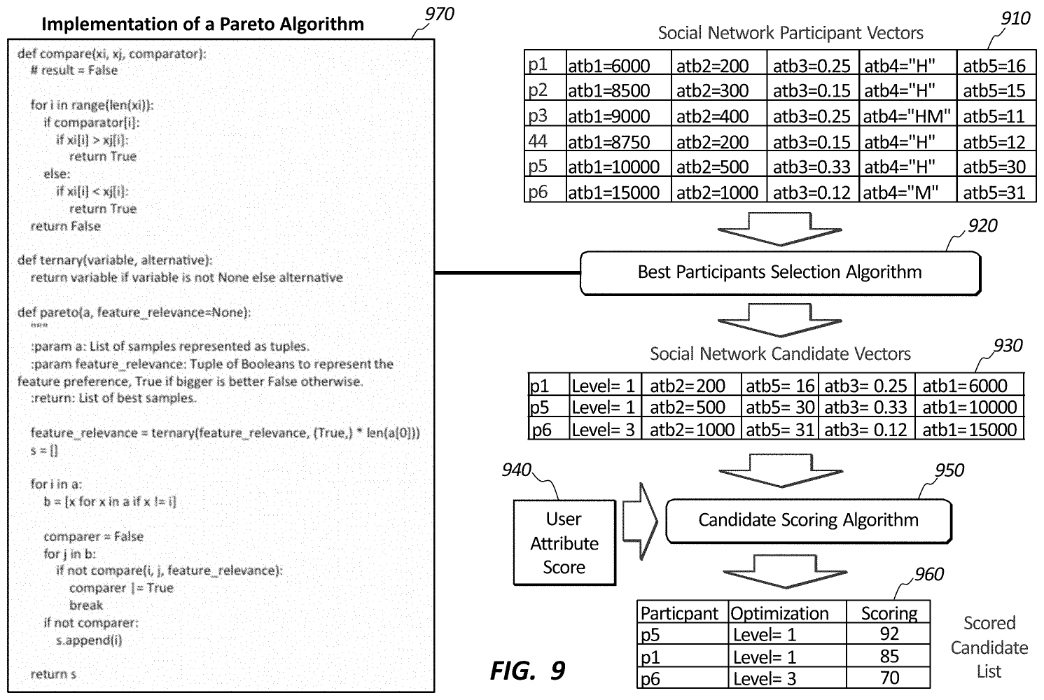

FIG. 9 is an illustration of the process to reduce through a multi-objective optimization algorithm the social network qualified participants vector 910 to social network best candidate participants vectors 930. The system applies the best participants selection algorithm vectors 920 to produce the social network best candidate participants 930 based on the objective function (e.g. maximal values) of each candidate attributes. The algorithm restricts through a minimum and maximum the number of selected candidates. As an example, the participant vector's minimum and maximum is set to the value of 3. The social network best candidate participants 930 is input into the candidate scoring algorithm 950, an algorithm that takes each participant record's attribute and applies the attribute score weight 940 to the attribute, totaling the overall score to the participant record. The candidate scoring algorithm 950 sorts the records by the record scores and outputs the scored candidate list 960.

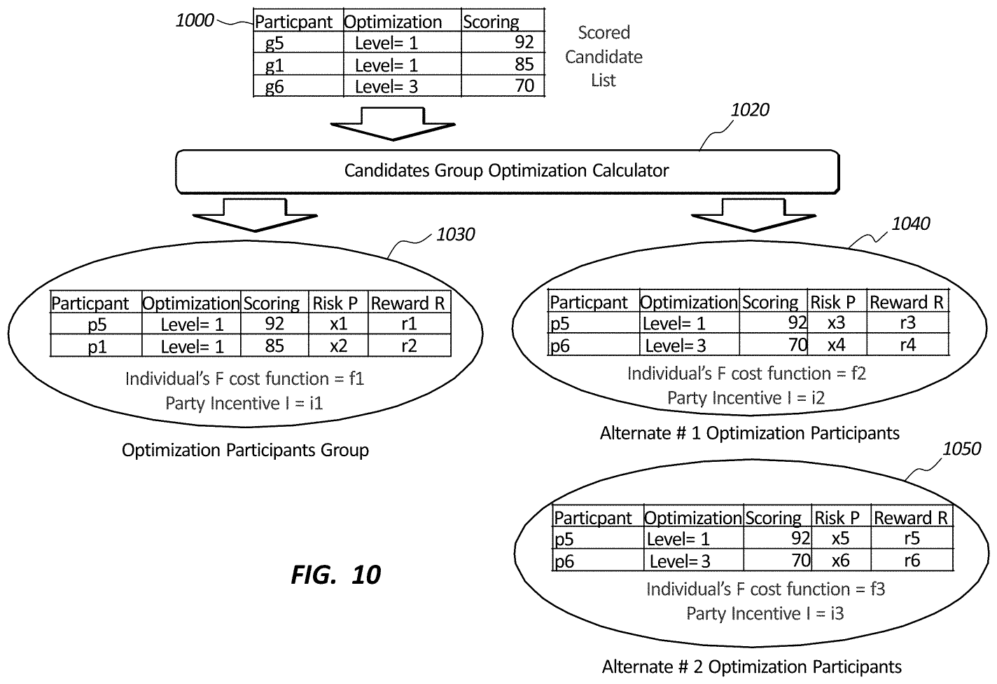

FIG. 10 is an illustration of embodiments of the participant groups—sets of participants in each group in which the same participant can be in more than one group, that are created through an ensemble of processes and algorithms, to produce for each group an individuals' optimized F cost function. Each group of participants potentially results in a different cost function value because of the composition and scoring of each participant, for each same participant within the different groups a calculated participant reward variable R and risk variable P. The system inputs the scored candidate list 1000 in candidates group optimization calculator 1020 that outputs an optimization participants group 1030 (most optimal) participants record set and two alternate optimization participants 1040 and 1050.

The optimization participants group 1030 includes the records for participants: p5 and p1, with participant p5 having risk variable P=x1 and reward variable R=r1 and participant p1 having risk variable P=x2 and reward variable R=r1. Participant p5 and p1 collectively contribute to the individual's F cost function value of f1 and to the party incentive I value of i1. Optimization participants group 1030 data is submitted to the participants negotiator 454.

The alternate optimization participants 1040 is the next optimal group, meaning that f1>f2 (and f2 is greater than f3 in 550 assuming that a greater F cost function is better) and i1<i2, where p5 and p6 collectively contribute to the individual's F cost function value of f2 and to the party incentive I value of i2. Also p5 is present in 1030 and 1040, but p5 having risk variable P=x3 and reward variable R=r3 where the following condition could be valid x1≠x3 and r1≠r3 or x1=x3 and r1=r3.

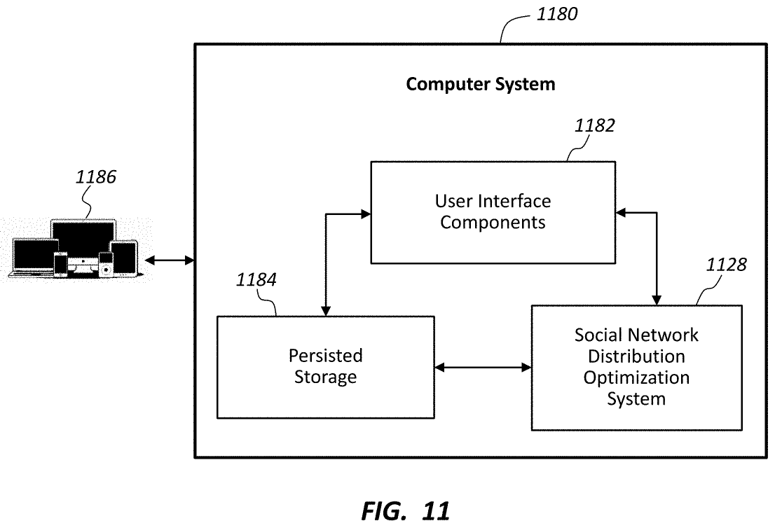

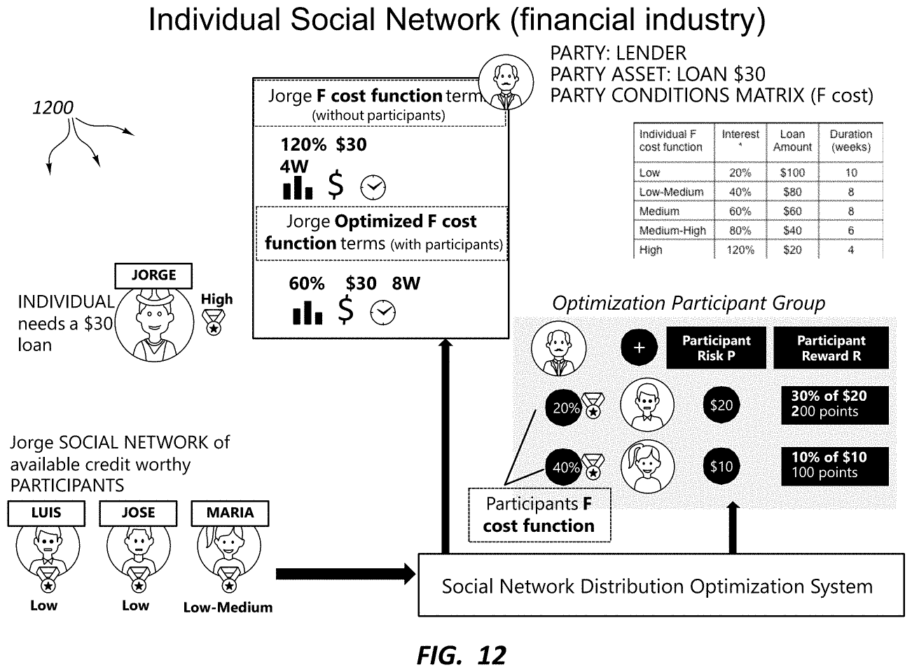

FIG. 11 depicts an example computer system 1180 that may be used to process the various embodiments described herein. The computer system 1180 may include one or more user interface components 1182, persisted storage 1184, and a social network distribution optimization system 1128 (e.g. 228 of FIG. 2). The computer system may be linked to other computer systems 1186 via wired or wireless network connections. The computer system 1180 may generate and provide UI components 1182 representing an individual's social network. Indeed, FIG. 12 depicts a use case of the social network distribution optimizer in the financial industry, where the party is depicted as a lender, the party asset is depicted as a loan, and the individual is depicted as a borrower (1200). The individual F cost function represents the terms for the loans (e.g. interest rate), and the party conditions matrix is based on the F cost functions as the different terms and conditions for a loan based on the risk profile of the borrowers or participants willing to lend a guarantee.

In 1200, the borrower's social network is shown, along with a flowchart illustrating the process through which Jorge is able to get optimized loan terms (e.g. lower interest rate) with the participation of a group of the social network connections, Maria and Jose. Through the use of participants, the resulting loan has terms better than what Jorge could have gotten. Further, both participants take a different level of risk, in terms of the amount each guarantees. Each is provided with a financial gain and reward incentive for taking the role of guaranteeing a portion of the loan amount.

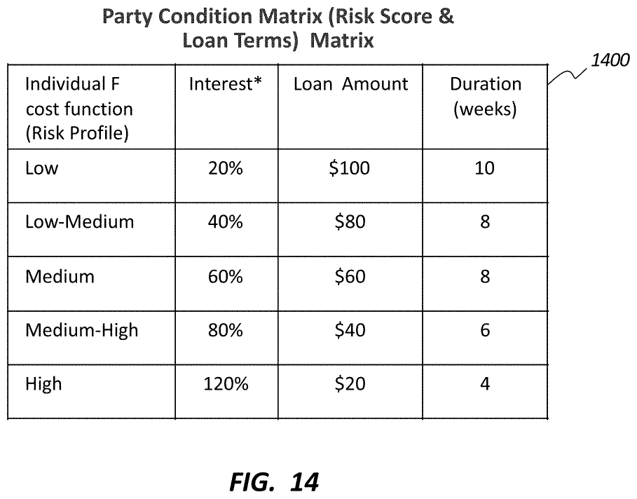

To illustrate the working of social network distribution optimizer in the financial industry in 1200, an individual borrower [Jorge] requests a loan from a lender. At least one of the embodiments herein may use the party condition matrix in the form of lender risk score and loan terms matrix illustrated in 1400 of FIG. 14. Jorge requests an asset in terms of a loan for $30. Jorge has a borrower risk score of high, and the proposed original F cost function expressed in loan terms are: interest rate of 120%, loan amount of $20, loan duration of four weeks, loan payment of $5.12 per period. Jorge has in the social network three participants—[Luis] with a risk score of low, [Jose] with a risk score of low and a current loan (asset) with a balance of $10, and [Maria] with a risk score of low-medium. The social network distribution optimizer receives the original loan terms (original F cost function) and the participants list [Luis][Jose][Maria].

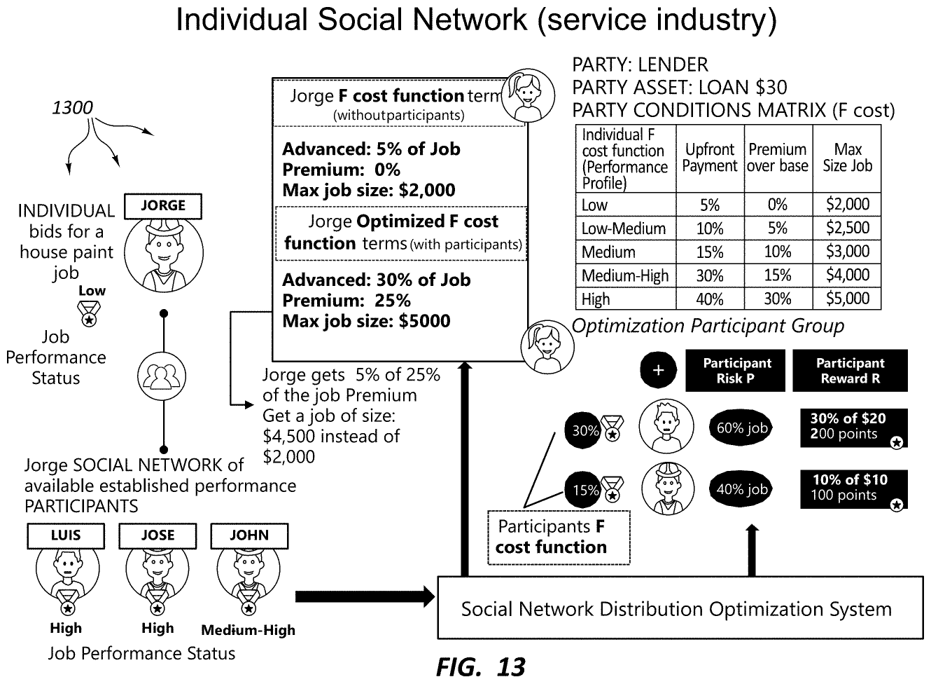

The social network distribution optimizer optimization algorithm ranks the participants as [Luis][Jose][Maria], based on the set of attributes that calculate each F cost function, increases the loan amount to the requested $30, sets [Luis] to have a risk guarantee amount to $20 and [Maria] to have a risk guarantee amount to $10, sets the optimized loan terms (F cost function) to an interest rate of 60%, loan amount of $30, loan duration of eight weeks, loan payment of $4.16 per period; and sets the participants reward for [Luis] (60%-20%-Lender premium)=30% on the guaranteed amount of $20 and for [Maria] (60%-40%-Lender premium)=10% on the guaranteed amount of $10 plus additional incentive rewards points. A similar process is performed in 1300 of FIG. 13, where the process discovers a participant network of [Luis][Jose][John] and ranks the participants, and then provides rewards for guaranteeing the asset commensurate with risk. At least some of the embodiments herein may use the party condition matrix 1500 in the form of risk score and upfront payments and premiums matrix when determining an individual's optimized F function and optimal participation group.

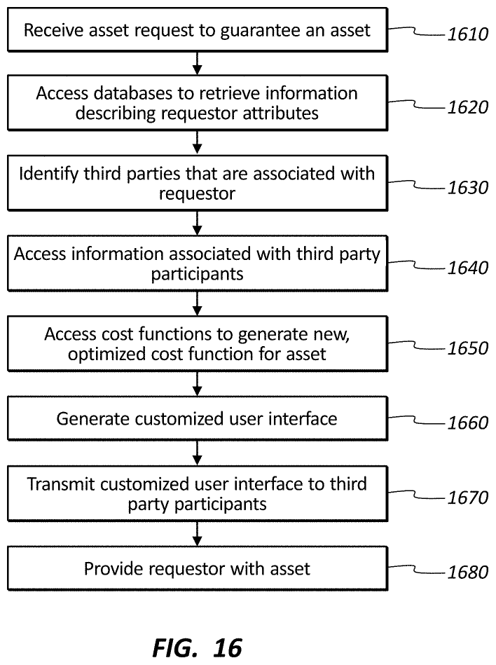

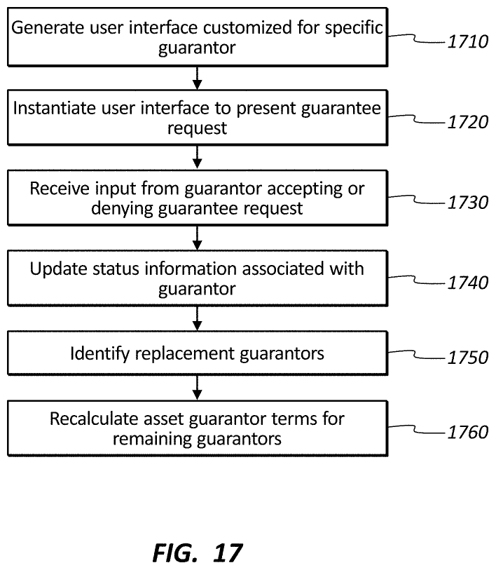

In view of the systems and architectures described above, methodologies that may be implemented in accordance with the disclosed subject matter will be better appreciated with reference to the flow charts of FIGS. 16 and 17. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 16 illustrates a flowchart of a method 1600 for providing a requestor with an asset that has been guaranteed by a guarantor. The method 1600 will now be described with frequent reference to the components and data of environment 100 of FIG. 1.

Method 1600 includes receiving data, from a requestor, including an asset request to guarantee a particular asset, the asset request including identification information for the requestor (1610). For example, receiver 105 may receive, from requestor 120, data including a request for an asset 119. The asset may be any type of product, service or other item which may be provided by a provider and backed by a guarantor. The asset request includes information identifying the requestor 120, so that providers (e.g. parties 223 from FIG. 2) and guarantors (e.g. participants 232 from FIG. 2) can determine who is requesting the asset 118.

Method 1600 includes accessing local or remote databases to retrieve information describing a set of attributes associated with the requestor, the set of attributes providing information for deriving a requestor cost function associated with the asset for the requestor, the cost function defining one or more terms or conditions upon which the asset will be provisioned to the requestor (1620). The data accessing engine 107 accesses local database 108 and/or other remote databases (not shown) to retrieve attribute information 109 for the requestor 120. The attributes 109 provide information that can be used to derive a requestor cost function (i.e. cost function F 222 of FIG. 2). The cost function F (110 of FIG. 1) is specific to the requestor 120 and the requested asset 118, and defines terms and conditions that will be required of the requestor to receive or have access to the asset. These terms may include a total amount to pay, interest rate, monthly payment, payment period, amount guaranteed by guarantor, or other terms.

Method 1600 includes identifying, through a permission-based network connection within a social database, one or more third parties that are associated with the requestor (1630). The social database information gathering tool 111 may query social database 125 (or multiple different social databases) to identify information regarding third parties 124 which may be friends, family or work associates of the requestor 120. Each third party 124 may have associated attributes 126 that are related to them personally, or to their status as guarantors (e.g. past experience with guaranteeing an asset). The data accessing engine 107 may access the attribute information 126 associated with the third party participants 124 (1640). The attribute information provides data for deriving a third party cost function 112 associated with the asset for the third party. This third party cost function 112 represents the risk to the party of becoming a guarantor for the asset.

Method 1600 next includes accessing the requestor cost function and the third party cost function to generate a new, optimized cost function for the asset for the requestor with a guarantee from one or more of the third parties (1650). For example, the analysis optimization engine 113 may access the requestor cost function 110 and the third party cost function 112 and may generate a new, optimized cost function 114 for the asset 118. This optimized cost function (e.g. 234 of FIG. 2) takes into account the third party's participation in the guarantee, which reduces the optimized cost function. As more participants opt in to be guarantors, the optimized cost function will continue to decrease, and the user will continue to receive better terms, as shown in FIGS. 5A and 5B, where the terms in FIG. 5A are reduced to the terms shown in FIG. 5B upon the participation of new guarantors.

Method 1600 next includes generating a customized user interface that includes an interactive visual arrangement of items associated with the asset including the optimized cost function, a request for a guarantee associated with the asset, a risk level of the requestor, a guarantee amount, and a reward amount for providing the guarantee (1660). The user interface generator 115 may generate custom user interface 500 or 600 from FIG. 5A or 6A, for example. Each element may be custom generated for the specific user's role. The requestor 120, for instance, would see a UI with options to make a request for an asset, as well as recommend potential guarantors or service/product providers.

The provider would see requestor info and terms associated with providing the asset. The provider may also see information about the guarantors or potential guarantors or others in the requestor's social network. The guarantors (i.e. third parties 124) may see information about the requestor 120, terms associated with the asset including the request for guarantee 129, a risk level 131, a guarantee amount 123 which the guarantor would be bound to, and a reward amount 132. Each of these UI elements 127 may be interactive, and may provide access to lower level information if desired, such as user attribute tables, condition matrices, social network connection lists, filtered lists, etc. The UI may present these tables and lists, and may allow users to edit or modify items in these lists to see how or if the optimized cost function 128 changes. Accordingly, the customized user interface 130 (or 500 or 600) may be specific to each user and/or each role in the asset provisioning process.

Method 1600 further includes transmitting at least a portion of the customized user interface to the identified one or more third party participants (1670) and, upon receiving from at least one of the third party participants a guarantee 122 and a guarantee amount 123, providing the requestor with the asset according to the optimized asset guaranteeing terms (1680). Thus, once the interested guarantors have opted in and the asset guarantor terms 117 have been agreed to, the provisioning module 116 may provide the asset 118 to the requestor 120, and the guarantors may receive at least a portion of their rewards.

The rewards for providing the guarantee may be static, or may change over time. The rewards are optimized based on risk and based on the guarantee amount. The group of participants thus takes a portion of risk in the asset guarantee and receives a commensurate reward (e.g. points, cash, etc.). The risk to the guarantors may be greater or smaller based on the requestor's attributes including an indication of the requestor's creditworthiness, reputation, or based on the provider's performance status (i.e. the provider does good work, has been working for a long time, etc.). The reward for providing the guarantee may be dynamically updated and optimized as the risk for the guarantee amount changes over time, as shown in the change from FIGS. 6A to 6B as additional guarantors are added.

The SNDOS 228 or “distribution optimizer” of FIG. 2 may be implemented to optimize the percentage of risk guaranteed by each guarantor and further optimize incentives for third parties to agree to reduce the total cost to the requestor who is receiving the asset. These incentives to lower the total cost may be countered by providing additional rewards or benefits to the third parties. The SNDOS 228 may adjust the risk level associated with the asset across multiple third parties based on profile information associated with the requestor and profile information associated with other third parties. In line with this, multi-objective optimization machine-learning techniques may be used to maximize benefits to both the requestor and the third parties.

When determining which third parties are to be part of a given asset guarantee, the computer system 101 may perform filtering to filter potential guarantors within the social database 125 based on criteria including past asset guarantees, financial capabilities, relationship to the requestor or other criteria. The filtering process may also calculate a cost function for the asset representing a performance risk, and filter potential guarantors based on the calculated cost function 114 for the asset 118. As explained above, the cost function may include a risk level, a status level, or a performance level. Thus, in this manner, a multi-objective optimization algorithm may be implemented to classify optimal potential guarantors within the social database based on selected criteria. The customized user interface 130 displays a list of potential guarantors that are part of the requestor's social network, along with a guarantor ranking associated with each guarantor, and an optimal guarantee amount 123 by each guarantor.

The analysis optimization engine 113 may be configured to generate an optimal guarantee amount for each third party based on that third party's attributes. Furthermore, the analysis optimization engine 113 may generate an optimal reward amount for each third party to guarantee the asset. Each of these amounts is determined and optimized using machine-learning techniques, including use of a Pareto algorithm (e.g. 970) of FIG. 9. A scoring module may be implemented to access third party attribute scores to create an overall score for the potential guarantors within the social database based on various criteria. The overall score may indicate whether a given third party should be considered as a guarantor for a specific asset, or should be taken from the pool of consideration.

Turning now to FIG. 17, a flowchart illustrates a method 1700 for negotiating an asset guarantee with one or more guarantors. The method 1700 will now be described with frequent reference to the components and data of environment 100 of FIG. 1.

Method 1700 includes generating a user interface customized for a specific guarantor among a plurality of guarantors, the customized user interface presenting to the guarantor attribute information associated with an individual (1710). For example, the user interface generator 115 may generate customized user interface 130 which includes multiple different interactive items 127 customized for the specific guarantor 124. The interface displays to the guarantor requestor attribute information 109 associated with the requestor 120. The UI 130 also presents to the guarantor a guarantee request 129 including a requested guarantee amount 123, a portion of the guarantee amount which is to be guaranteed by the guarantor, a total amount that is to be earned 132 by the guarantor for guaranteeing the asset, and an indication of which other guarantors have agreed to guarantee the asset (1720), as shown in FIGS. 12 and 13.

Method 1700 next includes receiving input 121 from the guarantor accepting or denying the guarantee request (1730) and, if the guarantor denied the guarantee request, the computer system updates status information associated with the guarantor in an associated guarantor database (1740), which may be all or part of social database 125. The analysis optimization engine identifies which guarantors could serve as a replacement for the guarantor that denied the guarantee request (1750), and recalculates the asset guarantor terms 117 for the remaining guarantors including requestor cost function for the asset for the requestor, the guarantee amount 123 for each guarantor and the reward 132 for each guarantor (1760). Thus, the risk to each guarantor can change as other guarantors are added or removed from the pool of guarantors. In the embodiments herein, the reward amount 132 can also change commensurate with the risk.

The guarantor scoring and filtering process described in FIGS. 7-10 may include selecting guarantors that will decrease the requestor cost function F and thereby lower the risk of providing the asset to the requestor. The participants negotiator 454 of FIG. 4 can negotiate and select who is participating in a pool of guarantors based on whether the cost function is improved based on their participation. In some cases, guarantors are only permitted to participate in guaranteeing an asset if the cost function F is improved by their participation. Guarantors also have control over whether they will join a given pool. The customized user interface 130 may include options for the guarantor to accept the guarantee request, deny the guarantee request, or modify the guarantee request and later accept the modified request. The customized user interface may present a guarantee amount for a service, a percentage of liability as total liability allowed for the guarantor based on the guarantor attributes, a guarantor reward including reward points or earned amount per period for guaranteeing the service, or other information.

In some cases, guarantors may be listed as designated backups in case other parties fall out. In such cases, if a guarantor declines to guarantee an asset, the customized UI 130 may show a list of backup guarantors. The third parties are part of the individual borrower's social network and have indicated their willingness to be guarantors, but may not be good fits for each product or service or other asset that is to be guaranteed. The UI may also show an interest rate spread between an optimized loan interest rate charged to the requestor and the rate the guarantor would pay the provider if the provider was providing the service directly to the guarantor.

In some implementations, a risk or compliance officer can define and configure a plurality of inference rules. These inference rules may be structured to specify certain conditions and/or exclusions that each participant in the group (e.g., the guarantors or even the requestors) must meet in order to be included in their respective groups. Notably, the risk or compliance officer can define or even reconfigure these inference rules to determine the qualifications or other criteria each participant must have in order to be included in the group (e.g., perhaps one criterion may be that farmers (i.e. a requestor) cannot be within a 5 mile proximity to another farmer who is included in the same group). After the optimizing process selects a list of participants, the system can then execute the inference rules (individual and/or group based) to include and/or exclude participants. The process may then be repeated until an optimized list of participants is generated, where each participant in the list meets all the inference rules.

A computer system for running an embodiment of the present invention is shown in FIGS. 1 and 11. A user may interact with the system using a computing device display, to access information, respond to request for data from the user by the invention and run the system. A computer system including a user interface component that support different communication protocols and interacts with the user, and stores information regarding borrowers, guarantors, loans, lenders, accounts, social connections in a database. The lending loan optimization system runs in the CPU and memory of the computer system, interacts with the database to retrieve and store information. The lending loan optimization system also interacts directly to the user through the user interface components or system.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Accordingly, systems, methods and user interfaces are provided which determine a balance between functional cost for a person to take on a network of guarantors and rewards to guarantors. An optimized asset provisioning amount is generated based upon characteristics of the user and the user's network connections. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A computer system comprising:
one or more processors;
a hardware receiver configured to receive data, from a requestor, including an asset request to guarantee an asset, the asset request including identification information for the requestor;
a data accessing engine configured to access local or remote databases to retrieve information describing a set of attributes associated with the requestor, the set of attributes providing information for deriving a requestor cost function associated with the asset for the requestor, the requestor cost function defining one or more asset guaranteeing terms upon which the asset will potentially be provisioned to the requestor;
a social database information gathering tool configured to:
identify, through a permission-based network connection within a social database, a group of one or more third parties that are associated with the requestor; and
access, within the social database, information relating to a set of attributes associated with the group of one or more third parties, the set of attributes providing information for deriving a third party cost function associated with the asset for the group of one or more third parties;
an analysis optimization engine configured to access the requestor cost function and the third party cost function to generate a new, optimized cost function for the asset for the requestor with a guarantee from a subgroup of third parties selected from the group of one or more third parties according to optimized asset guaranteeing terms;
a user interface generator configured to generate a customized user interface having a particular visual layout that visually displays the following user interface elements:
an original terms element displaying the one or more asset guaranteeing terms upon which the asset will potentially be provisioned to the requestor;
an optimized terms element displaying the optimized asset guaranteeing terms upon which the asset will potentially be provisioned to the requestor; and
a listing of the subgroup of third parties who are providing the guarantee for the optimized asset guaranteeing terms;
wherein the particular visual layout causes the customized user interface to simultaneously display: (i) the original terms element, (ii) the optimized terms element, and (iii) at least one third party included within the subgroup of third parties; and
a provisioning module that provides the requestor with the asset according to the optimized asset guaranteeing terms.

2. The computer system of claim 1, wherein the requestor has an associated set of attributes indicating a creditworthiness, a reputation, or a performance status.

3. The computer system of claim 1, wherein the particular visual layout of the customized user interface further includes a description of the asset.

4. The computer system of claim 3, wherein the particular visual layout of the customized user interface further includes a name of the at least one third party included in the subgroup and a label indicating the at least one third party is a guarantor.

5. The computer system of claim 1, further comprising a distribution optimizer which optimizes a percentage of risk guaranteed by each third party in the subgroup and which optimizes incentives for each third party in the group of third parties to agree to reduce a total cost to the requestor who is receiving the asset.

6. The computer system of claim 1, wherein a risk level associated with the asset is adjusted across multiple third parties based on profile information associated with the requestor and profile information associated with the multiple third parties.

7. The computer system of claim 1, further comprising a filtering module configured to filter potential guarantors within the social database based on one or more criteria.

8. The computer system of claim 7, wherein the filtering module is further configured to calculate a cost function for the asset representing a performance risk, and filter potential guarantors based on the calculated cost function for the asset.

9. The computer system of claim 1, wherein the requestor cost function comprises a risk level, a status level, or a performance level.

10. The computer system of claim 1, wherein the analysis optimization engine is further configured to generate an optimal guarantee amount for each third party in the group of third parties and to generate an optimal reward for each third party in the group of third parties to guarantee the asset.

11. A method, implemented at a computer system that includes at least one processor, for negotiating an asset guarantee with one or more guarantors, the method comprising:
generating a user interface customized for a specific guarantor who is selected from among a plurality of guarantors, wherein the user interface has a particular visual layout that visually displays the following user interface elements:
an optimized terms element displaying optimized asset guaranteeing terms upon which an asset will potentially be provisioned to a requestor;
a reward element displaying terms of a reward that will potentially be provided to the specific guarantor should the specific guarantor agree to the optimized asset guaranteeing terms; and
a request element identifying the specific guarantor as a potential guarantor for guaranteeing the optimized asset guaranteeing terms to the requestor who is also identified in the request element;
wherein the particular visual layout causes the user interface to simultaneously display: (i) the optimized terms element, (ii) the reward element, and (iii) the request element;
receiving input from the specific guarantor accepting or denying a guarantee request specifying the optimized asset guaranteeing terms;
upon receiving an indication that the specific guarantor denied the guarantee request, updating status information associated with the specific guarantor in an associated guarantor database;
identifying one or more other potential guarantors as a replacement for the specific guarantor that denied the guarantee request; and
recalculating the optimized asset guarantor terms.

12. The method of claim 11, further comprising:
selecting the one or more other potential guarantors based on a determination that the one or more other potential guarantors will decrease a requestor cost function associated with the asset and thereby lower a risk of providing the asset to the requestor.

13. The method of claim 12, wherein the one or more other potential guarantors are permitted to participate in guaranteeing the asset based on a determination that the requestor cost function is improved by their participation.

14. The method of claim 11, wherein the user interface presents liability in terms of a potential payment amount per period based on financial asset terms and conditions of an owner of the asset.

15. The method of claim 11, wherein the user interface includes options for the specific guarantor to accept the guarantee request, deny the guarantee request, or modify the guarantee request.

16. The method of claim 11, wherein the user interface presents a guarantee amount for a service and a percentage of liability as total liability allowed for the specific guarantor based on the optimized asset guaranteeing terms.

17. A method, implemented at a computer system that includes at least one processor, for providing a requestor with an asset that has been guaranteed by a guarantor, the method comprising:
receiving data, from a requestor, including an asset request to guarantee a particular asset, the asset request including identification information for the requestor;
accessing local or remote databases to retrieve information describing a set of attributes associated with the requestor, the set of attributes providing information for deriving a requestor cost function associated with the asset for the requestor, the requestor cost function defining one or more terms or conditions upon which the asset will potentially be provisioned to the requestor;
identifying, through a permission-based network connection within a social database, a group of one or more third parties that are associated with the requestor;
accessing, within the social database, information relating to a set of attributes associated with the group of one or more third parties, the set of attributes providing information for deriving a third party cost function associated with the asset for the group of one or more third parties;
accessing the requestor cost function and the third party cost function to generate a new, optimized cost function for the asset for the requestor with a guarantee from a subgroup of third parties selected from the group of one or more third parties;
generating a customized user interface having a particular visual layout that visually displays the following user interface elements:
an original terms element displaying the one or more asset guaranteeing terms upon which the asset will potentially be provisioned to the requestor;
an optimized terms element displaying the optimized asset guaranteeing terms upon which the asset will potentially be provisioned to the requestor; and
a listing of the subgroup of third parties who are providing the guarantee for the optimized asset guaranteeing terms;
wherein the particular visual layout causes the customized user interface to simultaneously display: (i) the original terms element, (ii) the optimized terms element, and (iii) at least one third party included within the subgroup of third parties; and
providing the requestor with the asset according to the optimized asset guaranteeing terms.

18. The method of claim 17, wherein the particular visual layout of the customized user interface displays at least two third parties included within the subgroup.

19. The method of claim 17, wherein the customized user interface further displays a guarantor ranking associated with each third party included in the subgroup.

20. The method of claim 17, wherein the particular visual layout includes a description of the asset.
